(19) United States
(12) Patent Application Publication
(10) Pub. No.: US 2007/0231449 A1
(43) Pub. Date: Oct. 4, 2007

(54) Non-starchy rice bran polysaccharides

(75) Inventors: Reddy Sastry V. Cherukuri, Folsom, CA (US); Rukmini Cheruvanky, Folsom, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: NutraCea, El Dorado Hills, CA (US)

(21) Appl. No.: 11/394,731

(22) Filed: Mar. 30, 2006

(51) Int. Cl. A23L 1/00

(52) U.S. Cl. 426/618

(57) ABSTRACT

A method is disclosed for the preparation of a novel composition comprising non-starchy polysaccharides derived from rice bran. The polysaccharides may be obtained from stabilized rice bran as well as commercially available products, such as RiSolubles.

### BACKGROUND OF THE INVENTION

Rice bran is used as a feed ingredient for its protein and lipid content. To the food industry, rice bran is a source of dietary fiber, protein and health oil. The composition of rice bran includes germ and is comparable in the quantities of protein, fiber, and ash content to that of other cereal brans. Oil, phosphorus and silica contents are notably higher in rice bran. Phosphorus, present mainly as phytin phosphorus (90%), is highest among all the cereal brans. Other minerals present in rice bran include potassium and magnesium, among others. Rice bran is high in B vitamins and tocopherols but contains little vitamin A and C. The nitrogen content of rice bran is 1-3%, most of which is protein nitrogen. The major protein fractions in bran are albumin and globulin. The chemical composition of rice bran is given in Table 1 (from Rice Chemistry and Technology, 3rd ed. (2004), edited by E. T. Champagne, American Association of Cereal Chemists, Inc., St. Paul, Minn., page 571).

TABLE 1
Chemical composition (w/w %, at 14% moisture) of Rice Bran

| Constituent | Composition |
|---|---|
| Crude Protein (% N × 6.25) | 12.0-15.6 |
| Crude fat (%) | 15.0-19.7 |
| Crude fiber (%) | 7.0-11.4 |
| Available carbohydrate (%) | 31.1-52.3 |
| Crude ash (%) | |
| Calcium (mg/g) | 0.3-1.2 |
| Magnesium (mg/g) | 5-13 |
| Phosphorus (mg/g) | 11-25 |
| Phytin phosphorus (mg/g) | 9-22 |
| Silica (mg/g) | 6-11 |
| Zinc (mg/g) | 43-258 |
| Thiamine (B1) (ug/g) | 12-24 |
| Riboflavin (B2) (ug/g) | 1.8-4.3 |
| Niacin (ug/g) | 267-499 |

Polysaccharides, sometimes called “glycans,” are relatively complex carbohydrates, compared to starch. They are polymers made up of many monosaccharides joined together by glycoside linkage. Important polysaccharides include starch, glycogen and cellulose. These are all polysaccharides with D-glucose as the repeat unit, differing only in amount of branching and the type of glycosidic bond linking the consituent subunits to each other.

Starch is a storage form of glucose in plants and found as insoluble granules in rice, wheat, potatoes, beans and cereals. Starch is composed of two kinds of polysaccharides called amylose (20%) and amylopectin (80%). Starches hydrolyze easily in water and acid to give smaller saccharides called dextrins, then maltose and finally glucose. Other polysaccharides are not so easily hydrolyzed to simpler sugars.

Considerable interest has been developed recently on rice bran non-starchy polysaccharides because of the nutritional properties of dietary fiber. Dietary fiber is important for maintaining health, e.g., preventing development of certain specific disorders such as obesity, diabetes, colon-rectal cancer and arteriosclerosis (Roth and Mehlman, 1978; Wisker et al, 1985).

Polysaccharides from certain medicinal mushrooms have been reported to possess anti-tumor, anti-inflammatory, hypoglycemic, cardiotonic, and immunostimulating properties. For example, polysaccharides (glucan and glucogalactomannan) from the Boletus edulis mushroom acted as antagonizers and neutralizers of inflammation mediators in rats. The polysaccharides caused lymphocyte counts to decrease while lymphocytes increased in pleural fluid (Grzybek et al, 1992). Beta-D-glucan, a polysaccharide present in the Ganoderma lucidum mushroom, is known to possess hypoglycemic, cardiotonic, anti-tumor, immunostimulating properties.

Rice bran polysaccharides are components of the cell wall and consist of both water-soluble and water-insoluble polysaccharides. The latter group of polysaccharides is also known as insoluble dietary fiber. The water-soluble non-starchy polysaccharides include hemicelluloses, α-celluloses and pectins. Rice bran does not contain 1-3 or 1-4 β-glucans but it does have α-glucans. The polysaccharides in rice bran are non-nutritional phytochemicals that are not absorbed or metabolized in the digestive tract and are of zero caloric value but appear to elicit certain physiological properties in maintaining health and preventing diseases.

A water-soluble arabinogalactan was isolated from the water-soluble hemicelluloses of rice bran and was demonstrated to have significant anti-tumor properties in gastrointestinal carcinoma. (Akeshita et al., 1992) and colon cancer (Cummings, 1992). Rice bran hemicelluloses have been demonstrated to have a significant effect in increasing the peripheral lymphocytes and enhancing the immune function (Takenaka and Itoyama, 1993). Rice bran hemicelluloses reduce thymus atrophy in rats (Takenaka, 1992). Hikino (1988) isolated purified four glycan fractions from rice bran hemicelluloses according to their molecular weights and named them as oryzabrans A, B, C and D. Each of these four glycans were shown to improve the peripheral utilization of insulin resulting in significant hypoglycemic activity (Hikino et al., 1988; Hikino and Hayashi, 1989). Several studies on rice bran hemicelluloses have demonstrated (Masayoshi et al, 1987) significant improvement in the immune function, anti-cancer, anti-diabetic, anti-inflammatory and hypolipidemic effects.

A modified arabinoxylan rice bran (MGN-3) has also been extracted from rice bran following the enzymatic treatment of the rice bran with an extract from Shitaki medicinal mushroom. MGN-3 contains polysaccharides and is an effective biological response modifier that increases NK cell activity, and potentiates the activity of conventional chemotherapeutic agents (M. Ghoneum and S. Gollapudi (2003) Cancer Letter 201:41-49). Rice bran extract by itself has been shown to exhibit fairly strong antiviral effect. The extract of rice bran with shitaki mushroom showed promising anti-cancer properties. The enhancement of human natural killer cell activity shown by MGN-3 (rice bran arabinoxylan immunomodulator) caused augmentation of NK cell activity. MGN-3 could be used as a new biological response modifier having possible therapeutic effects against cancer (Ghoneum, 1998).

A polysaccharide RON substance having anti-tumor activity against transplantable tumors has been isolated from rice bran by extraction with hot water and purification by precipitating with a polar organic solvent or by a salting-agent. The polysaccharide RON has also been shown to be an imuno-modulating agent, a host defence agent against infectious diseases and an inducer of tumor necrosis factor (Sugura Takeo et al., U.S. Pat. No. 4,762,825, Aug. 9, 1988).

One polysaccharide preparation isolated from rice bran has been shown to contain hypolipidemic factor of whole bran when given to rats fed with high-fat-cholesterol diet for four months (Vanugopal and Kurup, 1972). The rice bran-derived polysaccharide considerably increased the breakdown of cholesterol to bile salts and cause increased fecal bile salt excretion.

A water soluble polysaccharide fraction of rice bran and endosperm showed potent anticompliment activity, suggesting a new example of a natural biological immunomodulator response modifier in food (Yamagishi et al. (2003) Cereal Chemistry, 80:5-8).

The effect of rice bran hemicelluloses on 1,2-dimethylhydrazine-induced intestinal carcinogenesis was studied in male Fisher rats (Aoe et al, (1993) Nutr Cancer, 20:41-49). The incidence of DMH-induced colon tumors was significantly lower in rats fed with 4% RBH diet compared to rats fed a basal control diet.

The nutritive activity of soluble rice bran arabinoxylans in broiler diets has been evaluated by Annison et al. ((1995) Science, 36:479-488). Rice bran dietary fiber and polysaccharides are reported to have certain health benefits such as hypolipidemic effect, immunomodulator response and anticancer effect on intestinal carcinogenesis.

The usefulness of dietary fibers in the maintenance of health and in the development of certain specific disorders such as obesity, diabetes, cancer and arteriosclerosis has been well-demonstrated. Although certain dietary fiber formulations are available, a need exists for methods of obtaining high-yield, high-potency, rice bran-derived polysaccharide formulations with a long shelf life to maximize the benefits of rice bran-derived non-starchy polysaccharides to consumers, some of whom may be sensitive to additives and/or impurities in less pure commercially available rice bran products.

### SUMMARY OF THE INVENTION

The present invention relates to the preparation and therapeutic applications of non-starchy polysaccharide prepared from stabilized rice bran and/or “RiSolubles” the proprietary water-soluble formulation of Nutracea, obtained by the enzymatic (α-amylase) treatment of stabilized rice bran.

In one embodiment, the invention provides a method for preparing a water-soluble non-starchy polysaccharide from a stabilized rice bran, comprising subjecting the stabilized rice bran derivative to a defatting treatment, a starch-degrading treatment, a pancreatin treatment, and a precipitation step which yields precipitated water-soluble non-starchy polysaccharides. In a related embodiment, the defatting treatment comprises the use of a non-polar organic solvent to dissolve fats which are present in the rice bran derivative, then separating the resulting defatted rice bran derivative from the fat-containing solvent. In another related embodiment, the non-polar organic solvent is selected from the group consisting of hexane, ether, and petroleum ether.

In yet another related embodiment, the starch-degrading treatment in the method for preparing a water-soluble non-starchy polysaccharide from stabilized rice bran follows the defatting treatment. In a further related embodiment, the starch-degrading treatment comprises exposing a defatted rice bran derivative fraction to alpha amylase. In a related embodiment, the defatted rice bran derivative fraction is treated with alpha-amylase prior to treatment with pancreatin.

In another related embodiment, the precipitation step comprises adding ethyl alcohol to an aqueous solution of non-starchy polysaccharides that result from the deffatting, starch-degrading, and pancreatin treatments of said stabilized rice bran. In a related embodiment, the pure precipitated water-soluble non-starchy polysaccharides are isolated from the non-precipitated material.

In another embodiment, the invention provides a method for preparing a water-soluble non-starchy polysaccharide from RiSolubles, comprising the steps of subjecting RiSolubles to a defatting treatment, a pancreatin treatment, and a precipitation step which yields precipitated water-soluble non-starchy polysaccharides. In a related embodiment, the defatting treatment comprises dissolving fats in RiSolubles using a non-polar organic solvent and separating the resulting defatted rice bran derivative from the fat-containing solvent. In another related embodiment, the non-polar organic solvent is selected from the group consisting of hexane, ether, and petroleum ether. In yet another related embodiment, the method, the pancreatin treatment follows defatting of RiSolubles.

In another related embodiment, the precipitation step comprises adding ethyl alcohol to an aqueous solution of non-starchy polysaccharides which results from the deffatting, starch-degrading, and pancreatin treatment of RiSolubles. In yet another related embodiment, pure precipitated water-soluble non-starchy polysaccharides are isolated from the non-precipitated material following the addition of ethyl alcohol.

In yet another related embodiment of the methods for purifying water-soluble non-starchy polysaccharides from stabilized rice bran or RiSolubles, the precipitated water-soluble non-starchy polysaccharides obtained by the methods are solubilized, then separated further by molecular weight. In a related embodiment, the separation yields at least one group of polysaccharides with average molecular weights between 35 kD and 45 kD.

In another embodiment, the invention provides water-soluble non-starchy polysaccharide products derived from stabilized rice bran or Risolubes according to the above-described methods. In yet another embodiment, the invention provides a water-soluble non-starchy polysaccharide composition derived from rice bran, comprising polymers of glucose, arabinose and xylose, wherein said polymers are branched, and wherein the ratio of 4-linked glucopyranosyl residues to terminal glucopyranosyl residues in the polymers is at least 2:1. In yet another embodiment, the invention provides a water-soluble non-starchy polysaccharide composition derived from rice bran, comprising polymers of glucose, arabinose and xylose, wherein the polymers are branched, and wherein the molecular weights of at least 10% w/w, or preferably at least 30% w/w, of the polysaccharides in the composition are between 35 and 45 kD. In yet another embodiment, the polymers in the composition are branched, and the ratio of 4-linked glucopyranosyl residues to terminal glucopyranosyl residues in the polymers is at least 2:1.

In another embodiment, the invention provides a water-soluble non-starchy polysaccharide composition derived from rice bran, comprising polymers of glucose, arabinose and xylose, wherein the polymers are branched, and wherein the molecular weights of at least 90% w/w of the polysaccharides in the composition are between 35 and 45 kD. In another embodiment, the invention provides a water-soluble non-starchy polysaccharide composition derived from rice bran, comprising polymers of glucose, arabinose and xylose, wherein the polymers are branched, and wherein the molecular weights of at least 90% w/w of the polysaccharides in the composition are between 4 and 7 kD.

In further embodiments, the invention provides methods of treating animal subjects, including human subjects, with the compositions of the invention. For example, in one such embodiment, the invention provides a method of reducing the likelihood of a disease in a subject, comprising administering an effective amount of the water-soluble non-starchy polysaccharides of the invention to a subject, wherein the disease is selected from the group consisting of diabetes, arthritis, a cardiovascular disease, an auto-immune disease, a disease of the liver, and cancer. In a related embodiment, the subject is at higher risk for said disease than an average subject. In another related embodiment, approximately 1 to approximately 5 grams of said composition are administered to the subject on a daily basis. In yet another related embodiment, the higher risk of disease in said subject is determined prior to the administration of the water-soluble non-starchy rice bran-derived polysaccharides. In yet another related embodiment, the determination of higher disease risk comprises the use of a genetic test. In yet another related embodiment, prior to the administration of the water-soluble non-starchy polysaccharide composition, the subject is determined to be allergic to a substance that is present in other commercial rice bran-derived products but not present in the water-soluble non-starchy polysaccharide compositions of the invention.

The invention also provides a method for improving gastro-intestinal and colon health in a subject, comprising administering to the subject an effective amount of the water-soluble non-starchy polysaccharide compositions of the invention. In another embodiment, the invention provides a method of facilitating the growth of bifido bacteria in the intestines of a subject, comprising administering to the subject an effective amount of the water-soluble non-starchy polysaccharide compositions of the invention. In yet another embodiment, the invention provides a method of reducing the frequency or duration of a viral, bacterial or fungal infection in a subject, comprising administering to the subject an effective amount of the water-soluble non-starchy polysaccharide compositions of the invention

In one embodiment, the invention also provides a skin cream or lotion comprising a rice bran-derived water-soluble non-starchy polysaccharide composition described herein. In another embodiment, the invention provides a method for therapeutically or prophylactically treating signs of skin aging in a mammalian subject comprising the step of topically administering an effective amount of a rice bran-derived water-soluble non-starchy polysaccharide composition described herein.

In another embodiment, the invention provides a rice bran-derived water-soluble non-starchy polysaccharide prepared from stabilized rice bran according to the method represented in Scheme-1 (FIG. 1). In another embodiment of the invention, the invention provides a rice bran-derived water-soluble non-starchy polysaccharide prepared from RiSolubles according to the method represented in Scheme-2 (FIG. 2).

### BRIEF DESCRIPTION OF THE FIGURES

FIG. 1 shows an illustration of Scheme 1, a process for purifying non-starchy polysaccharides from stabilized rice bran.

FIG. 2 shows an illustration of Scheme 2, a process for purifying non-starchy polysaccharides from RiSolubles.

### DETAILED DESCRIPTION OF THE INVENTION

In one embodiment of the invention, the rice bran non-starchy polysaccharide is the water-soluble fraction of enzyme-cleaved defatted stabilized rice bran, where the enzymes utilized are α-amylase and pancreatin. In another embodiment, the rice bran non-starchy polysaccharide is prepared from defatted RiSolubles (the α-amylase treated water-soluble fraction of rice bran) by treating defatted RiSolubles with pancreatin.

The term “stabilized rice bran” refers to rice bran which has been treated to inactivate rice bran lipase which, if left active, catalyzes the breakdown of fats in rice bran render rice bran unfit for human consumption. Rice bran may be stabilized using chemical treatments (e.g., using acid or bases), physical treatments (e.g., by heating), enzymatic treatments, or a combination of one or more of these treatments. The methods described herein for obtaining water-soluble non-starchy polysaccharides from stabilized rice bran may be modified for obtaining such polysaccharides from non-stabilized or “raw” rice bran. For example, a first step of inactivating lipase in a non-stabilized rice bran starting material (e.g., using one or more of the lipase-inactivating treatments described above) may be employed. The stabilized rice bran thus obtained may be treated according to the methods described herein.

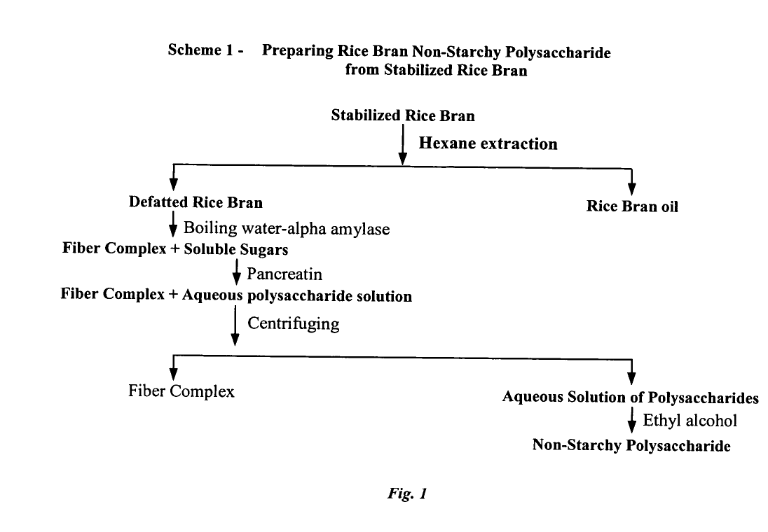

Scheme 1 for preparing a rice bran non-starchy polysaccharide is shown in FIG. 1. The method comprises degrading the starch present in the stabilized rice bran by treating with α-amylase enzyme. The resulting fiber complex and water-soluble sugars are further treated with pancreatin to digest the protein. The non-starchy polysaccharide is then isolated from the aqueous solution after separating the fiber. Additional details relating to various steps in the process are described below.

Preferably, the preparation of the non-starchy polysaccharides of the invention begins with the extraction of fat from stabilized rice bran using a suitable non-polar organic solvent including, but not limited to, hexane, ether, or petroleum ether. Hexane is preferred. The extraction may be carried out once, twice, or, preferably, three or more times using sufficient quantities of the solvent. A Soxhlet extractor may be employed to facilitate the extracting process. The solvent layer containing the rice bran oil may be separated by vacuum filtration, centrifugation, or other means. The resulting defatted stabilized rice bran should be dried thoroughly to completely remove traces of solvent, e.g., by areal drying. After defatting, the rice bran contains 2% fat or, preferably, less than 2% fat.

The defatted rice bran is treated with an enzyme to degrade the starch present in the defatted rice bran. A preferred enzyme for this purpose is α-amylase, but one or more other starch-degrading enzymes could be used, in addition to α-amylase or in the alternative. A sufficient amount of enzyme is added to achieve maximum starch degradation. Preferably, the α-amylase mixture is heated during this step to a temperature between 140° and 212° F.

The resulting mixture of fiber complex and water-soluble non-starchy saccharides is treated with pancreatin to degrade residual protein, fat and sugars. An aqueous solution of sodium hydroxide can be added to the mixture to stop the reaction, followed by stirring for one hour at room temperature. After this protein degradation step, the pancreatin reaction mixture is centrifuged. Following centrifugation, the aqueous layer containing the non-starchy polysaccharides is separated from the fiber complex.

The rice bran non-starchy polysaccharides are precipitated from the aqueous extract by adding ethyl alcohol. The precipitated polysaccharides are separated and purified further by dissolving them in a suitable solvent, e.g., water, then precipitating them a second time with ethyl alcohol. The saccharides may be dried and stored as a solid or resuspended in a suitable solution, e.g., sterile water.

Alternatively, the rice bran non-starchy polysaccharide can also be prepared from RiSolubles, a rice bran-derived formulation manufactured and sold by Nutracea Inc. (El Dorado Hill, Calif.). RiSolubles is a water-soluble derivative of stabilized rice bran, wherein the rice bran is stabilized utilizing a non-chemical process. Briefly, RiSolubles is obtained by first degrading stabilized rice bran by preparing a slurry of stabilized rice bran at 150° to 200° F. with α-amylase enzyme. The slurry is separated into water-insoluble fiber and a water-soluble fraction. The insoluble fiber is separated from the water-soluble fraction by centrifuging the mixture. The aqueous solution is subjected to spray drying or drum drying to give the water-soluble fraction as a pale yellow powder, which is available under the brand name “RiSolubles.” RiSolubles and the process for manufacturing RiSolubles is described in more detail in U.S. Pat. Nos. 6,303,586 and 6,126,943. The physical characteristics and chemical composition of RiSolubles are given in Table 2.

TABLE 2
Composition of RiSolubles

| Color & Texture | Pale yellow amorphous solid |
|---|---|
| Solubility | Partially soluble in water and |
| | completely soluble in hot |
| | water but insoluble in polar & |
| | non-polar Organic solvents |
| Fat | 23-30% |
| Protein | 6-9% |
| Total dietary fiber | 0-20% |
| Carbohydrates | 27-66% |
| Ash | 3-7% |
| Moisture | 2-7% |

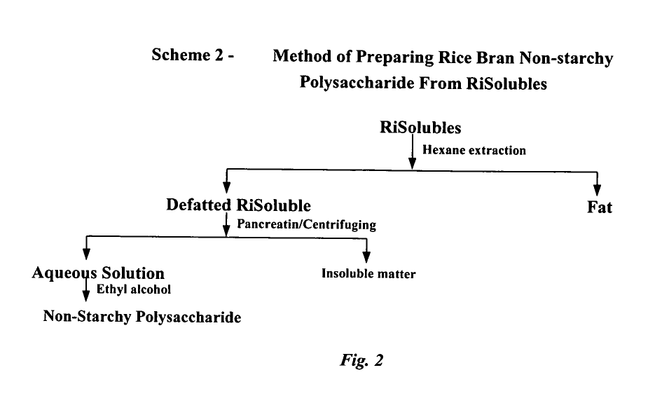

A preferred process using RiSolubles as a starting material for the preparation of a rice bran non-starchy polysaccharide is illustrated schematically in FIG. 2. Further details relating to this process are provided as follows.

Preferably, the preparation of the non-starchy polysaccharides of the invention begins with the extraction of fat from stabilized rice bran using a suitable non-polar organic solvent including, but not limited to, hexane, ether, or petroleum ether. Hexane is preferred. The extraction may be carried out once, twice, or, preferably, three or more times using sufficient quantities of the solvent. A Soxhlet extractor may be employed to facilitate the extracting process. The solvent layer containing the rice bran oil may be separated by vacuum filtration, centrifugation, or other means. The resulting defatted stabilized rice bran should be dried thoroughly to completely remove traces of solvent, e.g., by areal drying. After defatting, the rice bran contains 2% fat or, preferably, less than 2% fat.

The defatted RiSolubles are resolubilized in water and treated with pancreatin to desgrade protein, fat and sugars. Following centrifugation, the clear aqueous layer containing non-starchy polysaccharides is separated.

The non-starchy polysaccharides are precipitated from the clear aqueous layer by adding ethyl alcohol. The acqueous layer is separated from the precipitate by centrifugation or other appropriate means, e.g., filtration. The non-starchy polysaccharide is preferably purified further by resuspending the polysaccharide in fresh water, then re-precipitating the polysaccharides by the re-addition of ethyl alcohol.

Each of the rice bran non-starchy polysaccharides prepared according to the methods described above consists mainly of glucose, with appreciable amounts of arabinose, xylose, and galactose also present. A typical preparation of water-soluble non-starchy polysaccharides according to the methods described herein will yield a mixture of branched polysaccharides comprising 60-90% glucose, 2-10% arabinose, 1-5% xylose and 1-3% galactose (all measurements w/w). A preferred preparation will yield approximately 90% glucose, approximately 5% arabinose, approximately 2% xylose and between 0-1% galactose.

There are many ways to incorporate the soluble polysaccharides of the invention into the diet of a mammal. These include, but are not limited to, simply sprinkling the non-starchy rice bran polysaccharides on another food substance (salad, bread, cereal, etc.), incorporating it into a baked product (breads, muffins, waffles, etc), pasta, healthy dessert and snacks (athletic bar, healthy drink, etc.) and high fiber foods. The water-soluble non-starchy rice bran polysaccharides can be mixed with various food formulations, including, but not limited to, carriers and excipients. The water-soluble non-starchy rice bran polysaccharides can also be used in association with other therapeutic agents including, for example, antibiotics or antiviral agents. The water-soluble non-starchy rice bran polysaccharides can be fortified with other nutrients, such as phytonutrients and vitamins, in a customized basis. Such customized formulations can be customized on a per-patient basis, or the formulations may be customized for particular populations, e.g., diabetics, athletes, etc.

The enzyme treated stabilized rice bran derivative can be mixed into liquids such as juice or hot drinks, e.g., immediately prior to consumption. Additionally, it is appropriate for use in baked goods and other foodstuffs as discussed above.

A preferred method of consuming the rice bran-derived polysaccharides is oral consumption. Although the optimum dosage would be determined by the physician taking into account the age, weight and general health of the subject, and the purpose for which the polysaccharide composition is being consumed. As discussed above, the daily dosage can also be ingested in one or several treatments over a period of time, such as by way of single or multiple doses per day or from sustained release compositions.

The water-soluble non-starchy polysaccharide compositions provided by the invention and described herein are useful for the promotion and maintenance of health, generally. The compositions are also useful for the treatment and prevention of a variety of maladies which affect human beings and other animals, e.g., livestock, pets, songbirds, and other animals.

In particular, the water-soluble non-starchy polysaccharides of the invention are useful as an active agent in cosmeceuticals and skin-care products. The low molecular weight water-soluble non-starchy polysaccharides of the invention can be used to induce the synthesis of hyaluronic acid in skin collagen. For such treatments, the water-soluble non-starchy polysaccharides may be formulated as an anti-aging cream or lotion. The anti-aging properties of the water-soluble non-starchy polysaccharides are similarly advantageous to non-human animals such as cats, dogs, horses, and the like. The consumption and/or application of the polysaccharides may be used to impart increased gloss and/or shininess to the skin of such animals.

Symptoms or signs of skin aging which are susceptible to treatment with the compositions of the invention include, but are not limited to, all outward visible or otherwise perceptible manifestations including macro or micro skin aging effects. Such signs may be induced or caused by intrinsic factors or extrinsic factors, e.g. chronological aging and/or environmental damage. These signs may result from processes which include, but are not limited to, the development of textural discontinuities such as wrinkles, including both fine superficial wrinkles and coarse deep wrinkles, skin lines, crevices, bumps, large pores (e.g. associated with adnexal structures such as sweat gland ducts, sebaceous glands, or hair follicles), scaliness, flakiness and/or other forms of skin unevenness or roughness, loss of skin elasticity (loss and/or inactivation of functional skin elastin), sagging (including puffiness in the eye area and jowls), loss of skin firmness, loss of skin tightness, loss of skin recoil from deformation, redness or discoloration (including undereye circles), blotching, sallowness, hyperpigmented skin regions such as age spots and freckles, keratoses, abnormal differentiation, hyperkeratinization, elastosis, collagen breakdown, and other histological changes in the stratum comeum, dermis, epidermis, the skin vascular system (e.g. telangiectasia or spider vessels), and underlying tissues, especially those proximate to the skin.

Other benefits of the polysaccharides include: antiviral, antibacterial and antifungal properties; the promotion of liver health; anti-cancer activity; anti-inflammatory activity; immune system enhancing activity; the promotion of gastro-intestinal function, anti-diabetic activity; and hypocholesterolemic activity.

For all the treatments discussed herein, an effective amount of the non-starchy polysaccharides is administered. The term ” effective amount” as used herein means an amount of sufficient to significantly induce a positive benefit, including independently the benefits disclosed herein. The amount of water-soluble non-starchy rice bran-derived polysaccharides which is administered for any application should also be a safe amount, i.e., an amount which avoids serious side effects which outweight the benefits.

The following Examples provide additional details relating to particular embodiments of the invention but are not intended to be limiting.

### EXAMPLE 1

This example illustrates one method for preparing rice bran-derived non-starchy polysaccharide from stabilized rice bran.

Stabilized rice bran is extracted thoroughly with hexane in a Soxhlet extractor to remove the total fat completely and the defatted rice bran is dried under air. The dried defatted rice bran (250 g) is added in small portions to boiling hot water (2.5 L). Alpha-amylase (1.5 ml) (Genencor International) is added carefully with stirring to the suspension of defatted rice bran in hot water and the mixture is stirred for one hour at boiling temperature. It is cooled to 50-55° C., after which pancreatin (0.6 g) (Sigma Aldrich Co.) is added and stirring is continued at 45° C. for another hour. A solution of sodium hydroxide (20 g in 100 ml water) is added to the reaction mixture and stirred at room temperature for one hour. The pH of the reaction mixture is adjusted to 6-7 by adding glacial acetic acid and the resulting mixture is left over night (16-18 hr) at room temperature. This mixture is centrifuged for 20 minutes at 5000 rpm to separate the fiber complex from the aqueous solution containing non-starchy polysaccharide. The clear aqueous layer (1.75 L) is decanted and treated with ethyl alcohol (3.5 L) to obtain a cream-colored precipitate of rice bran non-starchy polysaccharide. The precipitate is collected by centrifuging for 20 minutes at 5000 rpm and further purified by dissolving in fresh boiling hot water and re-precipitating with ethyl alcohol. The purified polysaccharide is collected by centrifuging the mixture, then dried in an air oven at 80-90° C. for two hours to yield the pure water-soluble rice bran non-starchy polysaccharide as a cream-colored solid (42 g, 16.8% yield from defatted stabilized rice bran).

### EXAMPLE 2

This example illustrates the preparation of water-soluble rice bran non-starchy polysaccharide from RiSolubles (Nutracea Inc.; El Dorado Hills, Calif.).

RiSolubles (250 g) is extracted with hexane that\roughly to remove the fat completely and dried. The dry defatted RiSolubles (1 50 g) is added to water (500 ml) and heated to 500 C. To this is added pancreatin (1.5 g) and stirred for one hour at 50° C. It is cooled to room temperature and stirred with a solution of sodium hydroxide (20 g in 100 ml water) for one hour. The pH of the reaction mixture is adjusted to 6-7 by adding glacial acetic acid and left at room temperature for 14-16 hours. The mixture is centrifuged for 20 minutes at 5000 rpm and the clear aqueous layer is decanted. The non-starchy polysaccharide present in the aqueous layer is precipitated by addition of two volumes of ethyl alcohol. The separated non-starchy polysaccharide is collected by centrifuging the mixture and further purified by dissolving in fresh water and treating with ethyl alcohol as described in Example 1. The pure water-soluble non-starchy polysaccharide is obtained as a cream-colored amorphous solid (14 g, 7%) similar to the product obtained in Example 1.

Repeated investigations of the sort described herein show that stabilized rice bran comprises and RiSolubles comprise 10-15% and 9-12% water-soluble non-starchy polysaccharides, respectively.

### EXAMPLE 3

Clinical studies in human subjects with stabilized rice bran and RiSolubles showed that these compositions reduce the levels of serum glucose (U.S. Pat. No. 6,303,586 B1), serum cholesterol, LDL-C, apolipoprotein B and triglycerides (U.S. Pat. No. 6,126,943). RiSolubles also has demonstrated anti-inflammatory properties (U.S. Pat. No. 6,902,739).

The anti-viral, anti-carcinogenic, and immune-enhancing effects of RiSolubles were demonstrated with RiSolubles in several cases. For example, in one case a schoolteacher was suffering from an incurable liver disease. She was deemed to ill for a liver transplant. Her doctor gave her a few days to survive. She started taking RiSolubles and she dramatically improved. Her liver function tests showed dramatic improvement. After six months of taking RiSolubles, she needed no liver transplant and now she is back to work and is very healthy. Similar results with cancer patients were also reported.

The non-starchy polysaccharide compositions obtained using the processes described herein comprise rice bran-derived polysaccharides which are present in RiSolubles. The non-starchy polysaccharides of the present invention are available to deliver the benefits of RiSolubles and other rice bran derivatives with the additional advantage, for certain applications, of providing a purer preparation of rice bran-derived polysaccharides. For example, subjects who are allergic to one or more ingredients in RiSolubles or similar rice bran-derived mixtures may benefit from the purer preparations of rice bran-derived polysaccharides described herein.

### EXAMPLE 4

This Example summarizes a representative analysis of the chemical composition of the water-soluble polysaccharides derived from stabilized rice bran according to the method of Example 1.

Methods: Glycosyl composition analysis was performed by combined gas chromatography/mass spectrometry (GC/MS) of the per-O-trimethylsilyl (TMS) derivatives of the monosaccharide methyl glycosides produced by acidic methanolysis of the sample.

Methyl glycosides were first prepared from 200 μg of the dry sample provided by the client by methanolysis in 1 M HCl in methanol at 80° C. (18-22 hours), followed by re-N-acetylation with pyridine and acetic anhydride in methanol (for detection of amino sugars). The samples were then per-O-trimethylsilylated by treatment with Tri-Sil (Pierce) at 80° C. (0.5 hours). These procedures were carried out as previously described (Merkle R and Poppe I. Methods Enzymol. (1994) 230:1-15; York W et al. Methods Enzymol. (1985) 118:3-40). GC/MS analysis of the TMS methyl glycosides was performed on an HP 5890 GC interfaced to a 5970 MSD, using a Supelco DB-1 fused silica capillary column (30m×0.25 mm ID).

Glycosyl linkage analysis by the NaOH method: For glycosyl linkage analysis, the sample was permethylated, depolymerized, reduced, and acetylated. The resultant partially methylated alditol acetates (PMAAs) were analyzed by gas chromatography-mass spectrometry (GC-MS) as described by York et al (Methods Enzymol. (1985) 118:3-40). Inositol is added to the sample before derivatization as an internal standard (20 μg to each sample).

Initially, an aliquot of sample was permethylated by the method of Ciukanu and Kerek (Carbohydr. Res. (1984) 131:209-217; treatment with sodium hydroxide and methyl iodide in dry DMSO). The permethylation was repeated twice in order to aid complete methylation of the polymer. Following sample workup, the permethylated material was hydrolyzed using 2 M trifluoroacetic acid (2 h in sealed tube at 121° C.), reduced with NaBD₄, and acetylated using acetic anhydride/trifluoroacetic acid. The resulting PMAAs were analyzed on a Hewlett Packard 5890 GC interfaced to a 5970 MSD (mass selective detector, electron impact ionization mode). Separation was performed on a 30 m Supelco 2330 bonded phase fused silica capillary column.

Size exclusion chromatography: Size exclusion chromatography was performed on a portion of the sample by preparing a 10 mg/ml solution and injecting a 1 mg aliquot onto a Superdex 75 column at a flow rate of 0.40 ml/min in 50 mM ammonium formate, pH 4.8. Standards were run in tandem with this sample.

Results: The results of the glycosyl composition analysis described above are shown in Tables 3-5 and explained below.

The monosaccharides were identified by their retention times in comparison to standards and the carbohydrate character of the monosaccharides were authenticated by their mass spectra.

TABLE 3
Size exclusion chromatography

| Injection | Retention time |
|---|---|
| 6 KD standard | 23 minutes |
| 40 KD standard | 14 minutes |
| sample peak 1 | 15 minutes |
| sample peak 2 | 25 minutes |

TABLE 4
Glycosyl Composition Analysis

| Glycosyl residue | Mass (μg) | Mole %¹ |
|---|---|---|
| Arabinose (Ara) | 3.3 | 5.2 |
| Rhamnose (Rha) | n.d. | |
| Fucose (Fuc) | n.d. | |
| Xylose (Xyl) | 1.2 | 1.9 |
| Glucuronic acid (GlcA) | n.d. | |
| Galaturonic acid (GalA) | n.d. | |
| Mannose (Man) | n.d. | |
| Galactose (Gal) | <1.0 | <1 |
| Glucose (Glc) | 71.2 | 92.4 |
| N-acetyl galactosamine (GalNAc) | | n.d. |
| N-acetyl glucosamine (GlcNAc) | | n.d. |
| N-acetyl neuraminic acid | | n.d. |
| (NANA) | | |
| | | Σ = 75.7 |

¹Values are expressed as mole percent of total carbohydrate.
n.d. = none detected
Total percent carbohydrate by weight = 38%

TABLE 5
Glycosyl Linkage Analysis

| | Percentage |
|---|---|
| Glycosyl Residue | Present |
| terminal arabinofuranosyl residue (r-Ara f) | 6.6 |
| terminal glucopyranosyl residue (t-Glc) | 15.2 |
| 3-linked arabinopyranosyl residue (3-Ara p) | 1.2 |
| 3-linked glucopyranosyl residue (3-Glc p) | <1 |
| 3-linked galactopyranosyl residue (3-Gal p) | <1 |
| 6-linked glucopyranosyl residue (6-Glc) | 5.4 |
| 4-linked glucopyranosyl residue (4-Glc) | 62.8 |
| 4,6-linked glucopyranosyl residue (4,6-Glc) | 7.1 |

The results from size exclusion chromatography revealed the following information (Table 3). The sample chromatogram contained two peaks. The first peak eluted at 15 minutes, a retention time which is consistent with the standard at 40 kDaltons (kD). The second peak eluted at 25 minutes, a retention time slightly greater than the standard at 6 kD.

The 40 kD and 6 kD water-soluble polysaccharides in the composition are composed mainly of glucose (92%) but also include small amounts of arabinose and xylose. The linkage analysis showed that the glucan is mostly 4-Glc with small amount of 6-Glc and 4,6-Glc. The terminal glucose (15.2%) is the 1-linked glucose that is present at the ends of the polymer. The high percentage of terminal Glc compared to 4-Glc and the presence of the other detected linkages indicate that there is branching in the glucan and the polymers are not totally linear.

All publications, patents and patent applications mentioned in this specification are herein incorporated by reference into the specification in their entirety for all purposes.

Although the invention has been described with reference to preferred embodiments and examples thereof, the scope of the present invention is not limited only to those described embodiments. As will be apparent to persons skilled in the art, modifications and adaptations to the above-described invention can be made without departing from the spirit and scope of the invention, which is defined and circumscribed by the appended claims.

What is claimed is:

1. A method for preparing a water-soluble non-starchy polysaccharide from a stabilized rice bran, comprising:
subjecting said stabilized rice bran derivative to a defatting treatment, a starch-degrading treatment, a pancreatin treatment, and a precipitation step which yields precipitated water-soluble non-starchy polysaccharides.

2. The method of claim 1, wherein said defatting treatment comprises the use of a non-polar organic solvent to dissolve the fats in said rice bran derivative, and separating the resulting defatted rice bran derivative from the fat-containing solvent.

3. The method of claim 2, wherein said non-polar organic solvent is selected from the group consisting of hexane, ether, and petroleum ether.

4. The method of claim 1, wherein said starch-degrading treatment follows said defatting treatment; and wherein said starch-degrading treatment comprises exposing a defatted rice bran derivative fraction to alpha amylase.

5. The method of claim 1, wherein said pancreatin treatment follows said defatting treatment; and wherein said pancreatin treatment comprises exposing a defatted rice rice bran derivative fraction to pancreatin.

6. The method of claim 5, wherein said defatted rice bran derivative fraction is treated with alpha-amylase prior to said pancreatin treatment.

7. The method of claim 1, wherein said precipitation step comprises adding ethyl alcohol to an aqueous solution of non-starchy polysaccharides obtained from said deffatting, starch-degrading, and pancreatin treatments of said stabilized rice bran.

8. The method of claim 1, further comprising a step of isolating pure precipitated water-soluble non-starchy polysaccharides from non-precipitated material.

9. A method for preparing a water-soluble non-starchy polysaccharide from RiSolubles, comprising:
subjecting RiSolubles to a defatting treatment, a pancreatin treatment, and a precipitation step which yields precipitated water-soluble non-starchy polysaccharides.

10. The method of claim 9, wherein said defatting treatment comprises dissolving fats in RiSolubles using a non-polar organic solvent and separating the resulting defatted rice bran derivative from the fat-containing solvent.

11. The method of claim 10, wherein said non-polar organic solvent is selected from the group consisting of hexane, ether, and petroleum ether.

12. The method of claim 9, wherein said pancreatin treatment follows said defatting treatment; and wherein said pancreatin treatment comprises exposing a defatted RiSolubles fraction to pancreatin.

13. The method of claim 9, wherein said precipitation step comprises adding ethyl alcohol to an aqueous solution of non-starchy polysaccharides obtained from said deffatting, starch-degrading, and pancreatin treatments of RiSolubles.

14. The method of claim 9, further comprising a step of isolating pure precipitated water-soluble non-starchy polysaccharides from non-precipitated material.

15. The method of claim 8 or 14, further comprising solubilizing said pure precipitated water-soluble non-starchy polysaccharides and separating said polysaccharides by molecular weight, wherein said separation yields at least one group of polysaccharides with average molecular weights between 35 kD and 45 kD, wherein said group of polysaccharides represents at least 10% of said precipitated water-soluble non-starchy polysaccharides by weight.

16. The water-soluble non-starchy polysaccharide product of the process described in claim 8.

17. The water-soluble non-starchy polysaccharide product of the method of claim 14.

18. A water-soluble non-starchy polysaccharide composition derived from rice bran, comprising polymers of glucose, arabinose and xylose, wherein said polymers are branched, and wherein the ratio of 4-linked glucopyranosyl residues to terminal glucopyranosyl residues in said polymers is at least 2:1.

19. A water-soluble non-starchy polysaccharide composition derived from rice bran, comprising polymers of glucose, arabinose and xylose, wherein said polymers are branched, and wherein the molecular weights of at least 10% w/w of the polysaccharides in the composition are between 35 and 45 kD.

20. The composition of claim 19, wherein said polymers are branched, and wherein the ratio of 4-linked glucopyranosyl residues to terminal glucopyranosyl residues in said polymers is at least 2:1.

21. A water-soluble non-starchy polysaccharide composition derived from rice bran, comprising polymers of glucose, arabinose and xylose, wherein said polymers are branched, and wherein the molecular weights of at least 90% w/w of the polysaccharides in the composition are between 35 and 45 kD.

22. A water-soluble non-starchy polysaccharide composition derived from rice bran, comprising polymers of glucose, arabinose and xylose, wherein said polymers are branched, and wherein the molecular weights of at least 90% w/w of the polysaccharides in the composition are between 4 and 7 kD.

23. A method of reducing the likelihood of a disease in a subject, comprising administering an effective amount of the composition of any of claims 16-20 to a subject, wherein said disease is selected from the group consisting of diabetes, arthritis, a cardiovascular disease, an auto-immune disease, a disease of the liver, and cancer.

24. The method of claim 23, wherein said subject is at higher risk for said disease than an average subject.

25. The method of claim 24, wherein approximately 1 to approximately 5 grams of said composition are administered to a subject on a daily basis.

26. The method of claim 24, wherein said higher risk of disease in said subject is determined prior to the administration of said composition.

27. The method of claim 24, wherein said determination comprises the use of a genetic test.

28. The method of claim 23, wherein, prior to the administration of said non-starchy polysaccharide composition, said subject is determined to be allergic to a substance that is present in commercial rice bran-derived products, but not present in the compositions of claims 16-20.

29. A method of improving gastro-intestinal and colon health in a subject, comprising administering an effective amount of the composition of any of claims 16-20 to a subject.

30. A method of facilitating the growth of bifido bacteria in the intestines, comprising administering an effective amount of the composition of any of claims 16-20 to a subject.

31. A method of reducing the frequency or duration of viral, bacterial or fungal infections in a subject, comprising administering an effective amount of the composition of any of claims 16-20 to a subject.

32. A skin cream or lotion comprising the composition of any of claims 16-20.

33. A method for therapeutically or prophylactically treating signs of skin aging in a mammalian subject comprising administering an effective amount of the composition of claim 34.
